(19) United States
(12) Patent Application Publication
(10) Pub. No.: US 2024/0045653 A1
(43) Pub. Date: Feb. 8, 2024

(54) Method and Apparatus for Converting to Enhanced Block Floating Point Format

(71) Applicant: Arm Limited, Cambridge (GB)

(72) Inventors: Neil Burgess, Cardiff (GB); Sangwon Ha, Cambridge (GB); Partha Prasun Maji, Cambridge (GB)

(73) Assignee: Arm Limited, Cambridge (GB)

(21) Appl. No.: 17/878,277

(22) Filed: Aug. 1, 2022

(51) Int. Cl. G06F 5/01

(52) U.S. Cl. CPC G06F 5/012

(57) ABSTRACT

An apparatus and method of converting data into an Enhanced Block Floating Point (EBFP) format with a shared exponent is provided. The EBFP format enables data within a wide range of values to be stored using a reduced number of bits compared with conventional floating-point or fixed-point formats. The data to be converted may be in any other format, such as fixed-point, floating-point, block floating-point or EBFP.

### BACKGROUND

The range of numbers that can be represented in a fixed-point number system is limited by the number of bits used in the representation. The range can be increased using a Floating-Point (FP) representation or a Block Floating-Point (BFP) number system. A BFP number system represents a block of floating-point (FP) numbers by a shared exponent (typically the largest exponent in the block) and a block of right-shifted significands. Computations using BFP can provide improved accuracy compared to integer arithmetic and use fewer computing resources than full floating. However, the range of numbers that can be represented using a BFP format is limited, since small numbers are replaced by zero when the significands are right-shifted too far.

In some applications, such as computational neural networks, input data may have a very large range. The use of BFP in such applications can lead to inaccurate results. Also, in applications that use a large amount of data, the use of higher precision number representations may be precluded by limitations on storage resources.

### BRIEF DESCRIPTION OF THE DRAWINGS

The accompanying drawings provide visual representations which will be used to describe various representative embodiments more fully, and can be used by those skilled in the art to better understand the representative embodiments disclosed and their inherent advantages. In these drawings, like reference numerals identify corresponding or analogous elements.

FIG. 1 is a representation of a block of Enhanced Block Floating Point (EBFP) numbers, in accordance with various representative embodiments.

FIGS. 2A and 2B are diagrammatic representations of computer storage of an EBFP number, in accordance with various representative embodiments.

FIGS. 3A and 3B are diagrammatic representations of computer storage of an EBFP number, in accordance with various representative embodiments.

FIG. 4 is a block diagram of an apparatus for converting a floating-point number into an enhanced block floating-point number, in accordance with various representative embodiments.

FIG. 5 is a block diagram of an exponent unit, in accordance with various representative embodiments.

FIG. 6 is a block diagram of an encoder, in accordance with various representative embodiments.

FIG. 7 is a flow chart of a computer-implemented method for converting a floating-point number into an EBFP number, in accordance with various representative embodiments.

FIG. 8 is a flow chart of a method for encoding a significand to a EBFP number, in accordance with various representative embodiments.

FIG. 9 is a flow chart of a method for encoding an exponent difference to a EBFP number, in accordance with various representative embodiments.

FIG. 10 is a flow chart of a method for rounding when converting from a 32-bit floating point number to an EBFP number with 8-bits, in accordance with various representative embodiments.

FIG. 11 is a flow chart of a method for converting from a 32-bit floating point number to an EBFP number with 8-bits, in accordance with various representative embodiments.

FIG. 12 is a block diagram of a data processing apparatus for converting fixed-point numbers, in accordance with various representative embodiments.

FIG. 13 is a block diagram of a data processing apparatus for converting a block of fixed-point numbers, in accordance with various representative embodiments.

FIG. 14 is a block diagram of a data processing apparatus for combining block of numbers, in accordance with various representative embodiments.

FIG. 15 is a flow chart of a computer-implemented method of converting an input number to a number in EBFP format, in accordance with various representative embodiments.

FIG. 16 is a flow chart of a computer-implemented method of converting one or more blocks of numbers into a single block of numbers in EBFP format, in accordance with various representative embodiments.

### DETAILED DESCRIPTION

The various apparatus and devices described herein provide mechanisms for data processing using and enhanced block floating point data format.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

The present disclosure relates to an apparatus and method of converting data into an Enhanced Block Floating Point (EBFP) vector with a shared exponent. The EBFP format enables data within a wide range of values to be stored using a reduced number of bits compared with conventional floating-point or fixed-point formats. The data to be converted may be in any other format, such as fixed-point, floating-point, block floating-point or EBFP. The description below explains, for example, how shorter data blocks may be combined into longer data blocks. It will be apparent, to those of ordinary skill in the art, that longer EBFP data blocks may be split into shorter EBFP blocks in a similar manner.

The disclosed format may be used, for example, in applications where vector and matrix operations, such dot-product calculations, are performed on a large amount of data. In this application, the EBFP format is more compact and requires less memory and storage.

In a neural network, for example, feature maps may be encoded using an EBFP format. The results of computations on the features maps may be held in wide, fixed-point accumulators. The mechanisms disclosed herein enable these fixed-point accumulated values to be converted to EBFP format. The mechanisms also enable multiple fixed-point data to be encoded into a single EBFP vector with a single shared exponent. Still further, the mechanisms enable two or more EBFP blocks (including scalar EBFP numbers each with one exponent field and one payload) to be combined into a single, longer EBFP block.

The apparatus may be, for example, a neural processing unit (NPU), vector processing unit, graphics processing unit, digital signal processor or hardware accelerator. The format conversion may be performed using dedicated logic circuits or field programmable circuits, for example.

A number may be represented as (−1)^{s}×m×b^{e}, where s is a sign value, m is a significand, e is an exponent and b is a base. In some binary (b=2) floating-point representations, such as the 32-bit IEEE format, the significand is either zero or normalized to be in the range 1≤m<2. For non-zero values of m, the value m−1 is referred as the fractional part of the significand. The 32-bit IEEE format stores the exponent as an 8-bit value and the significands as a 23-bit value.

A Block Floating-Point (BFP) number system represents a block of floating-point (FP) numbers by a shared exponent (typically the largest exponent in the Block) and right-shifted significands of the block of FP numbers. The present disclosure improves upon BFP by representing small FP numbers (that would ordinarily be set to zero) by the difference between the exponent and the shared exponent. A tag field indicates whether the EBFP number represents a shifted significand or the exponent difference.

Some data processing applications, such as Neural Network (NN) processing, require very large amounts of data. For example, a single network architecture can use millions of parameters. Consequently, there is great interest in storing data as efficiently as possible. In some applications, for example, 8-bit scaled integers are used for inference but data for training requires the use of floating-point numbers with a greater exponent range than the 16-bit IEEE half-precision format, which has only 5 exponent bits. A 16-bit “Bfloat” format has been used successfully for NN training tasks. The Bfloat format has a sign bit, 8 exponent bits, and 7 fraction bits (denoted as s,8e,7f). Other FP formats have been proposed recently, including “DLfloat” which has 6 exponent bits and 9 fraction bits (s,6e,9f) as well as other 8-bit formats having more exponent bits than fraction bits (such as s,4e,3f and s,5e,2f). Block Floating-Point (BFP) representation has been used in a variety of applications, such as NN and Fast Fourier Transforms. In BFP, a block of data shares a common exponent, typically the largest exponent of the block to be processed. The significands of FP numbers are right-shifted by the difference between their individual exponents and the shared exponent. BFP has the added advantage that arithmetic processing can be performed on integer data paths saving considerable power and area in NN hardware implementation. BFP appears particularly well-suited to computing dot products because numbers with smaller exponents will not contribute many bits, if any, to the result. However, a difficulty with using BFP for processing Convolutional Neural Networks (CNNs) is that output feature maps are derived from multiple input feature maps which can have widely differing numeric distributions. In this case, many or even most of the numbers in a BFP scheme for encoding feature maps could end up being set to zero. By contrast, the weights employed in CNNs are often normalized to the range −1 . . . +1. Given that successful training and inference is usually dependent on the highest magnitude parameter of each filter, blocks of weights need exponents to sit only within a relatively small range.

TABLE 1 shows an example dot product computation for vector operands A and B. The number are denoted by hexadecimal significands with radix 2 exponents. Corresponding decimal significands and exponents are shown in brackets. The maximum of each vector is shown in bold font.

TABLE 1
Dot Product for Real Numbers

| Op A | Op B | OpA × OpB |
|---|---|---|
| +0x1.39p − 17 (1.22 × 2⁻¹⁷) | −0x1.40p − 5 (−1.25 × 2⁻⁵) | −0 x1.8740p − 22 (−1.53 × 2⁻²²) |
| −0x1.ccp + 20 (−1.80 × 2²⁰) | +0x1.fap − 6 (1.98 × 2⁻⁶) | −0x1.c69cp + 15 (−1.78 × 2¹⁵) |
| +0x1.bbp + 7 (1.73 × 2⁷) | +0x1.dep + 19 (1.87 x 2¹⁹) | +0x1.9d95p + 27 (1.62 × 2²⁷) |
| −0x1.d8p + 11 | −0x1.49p + 0 | +0x1.2f4cp + 12 |
| +0x1.dfp − 12 | +0x1.8cp − 10 | +0x1.727ap − 21 |
| −0x1.d9p + 19 (−1.85 × 2¹⁹) | −0x1.0ap + 9 | +0x1.eb7ap + 28 |
| +0x1.f2p − 17 | −0x1.41p+13 (−1.25 × 2¹³) | −0x1.3839p − 3 |
| +0x1.d1p − 7 | +0x1.ecp − 20 | +0x1.bedp − 26 |
| | Result | +0x1.5d1bp + 29 |

TABLE 2 shows the same dot product computation for vector operands A and B performed using Block Floating Point arithmetic. In this example, the dot product is calculated as zero because a number of small operands are represented by zero in the Block Floating Point format.

TABLE 2
Dot Product using Block Floating Point

| Op A (p + 20) | Op B (p + 19) | Op A × Op B |
|---|---|---|
| 0 | 0 | 0 |
| −0x1.cc (−1.80) | 0 | 0 |
| 0 | +0x1.de (1.87) | 0 |
| 0 | 0 | 0 |
| 0 | 0 | 0 |
| −0x0.ed (-0.93) | 0 | 0 |
| 0 | −0x0.05 (−0.02) | 0 |
| 0 | 0 | 0 |
| | BFP Result | 0 |

This example illustrates that conventional Block Floating Point arithmetic is not well suited for used where data a large range of values.

The present disclosure uses a number format, referred to as Enhanced Block Floating Point (EBFP). The format may be used in applications such as convolutional neural networks where (i) individual feature maps have widely differing numeric distributions and (ii) filter kernels only require their larger parameters to represented with higher accuracy.

In accordance with various embodiments, the exponent of a floating number to be encoded is compared with the shared exponent: when the difference is large enough that the BFP representation would be zero due to all the significand bits being shifted out of range, the exponent difference is stored; otherwise, the suitably encoded significand is stored.

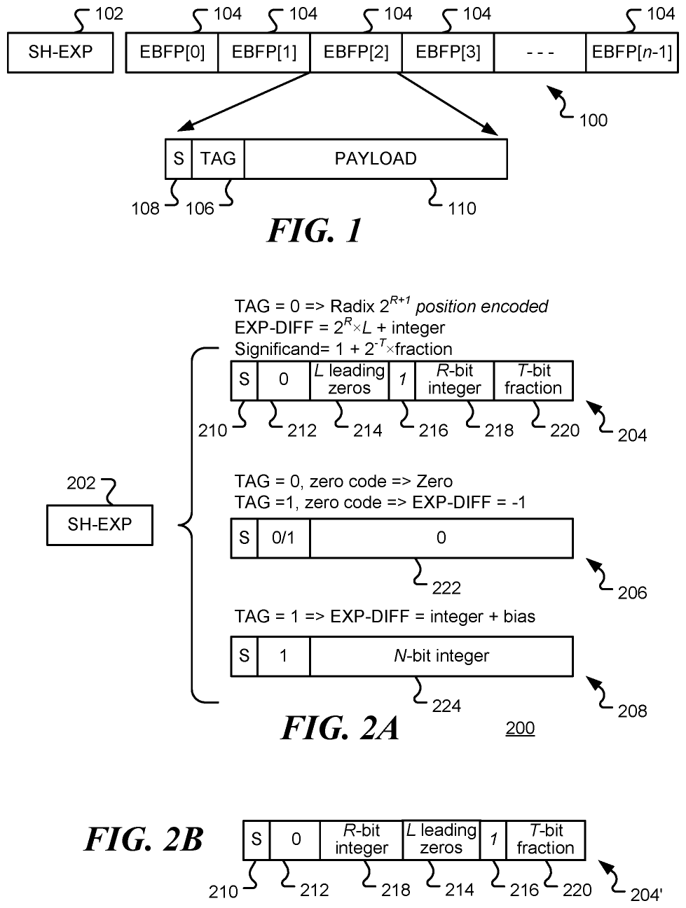

FIG. 1 is a representation of a block of Enhanced Block Floating Point (EBFP) numbers 100. Each number is represented by shared exponent 102 and an M-bit word 104, where M is an integer such as 8 or 16 for example. Word 104 includes one or more tag bits 106, a sign bit 108 and a number of bits for storing a payload 110 indicative of either the exponent difference or an encoded significand. For example, a number may be represented by an 8-bit base exponent and an 8-bit word having one or two tag bits, a sign bit and 5 or 6 bits for storing either the exponent difference or the encoded significand. In this example, the EBFP format implements a floating-point number system with 5 or 6 exponent bits and 1 to 6 significand bits. In contrast to prior formats, the allocation of payload bits between exponent bits and significand bits is variable.

In accordance with an embodiment of the disclosure, a number in floating-point format is converted to a number in EBFP format in a data processor. An input value having a sign, an exponent and a significand is encoded by determining an exponent difference between a base exponent and the exponent, setting one or more tag bits of an output value based on the exponent difference. When the exponent difference is less than a first threshold, the significand and exponent difference are encoded to a payload of the output value. When the exponent difference is not less than the first threshold, only the exponent difference is encoded to the payload of the output value. A sign bit in the output value is set corresponding to the sign of the input value, and the output value is stored.

The EBFP format is described in more detail below with reference to an apparatus for converting a floating-point (FP) number to an EBFP. In addition to the encoding scheme, two other aspects of EBFP are described: (a) rounding, and (b) special values. Rounding can be employed when converting a floating-point number into EBFP to preserve as much accuracy as possible. In one embodiment, a round-to-nearest scheme is used (ties away; i.e., round up when the guard bit is set) so that the upper fraction bits of 8-bit and 16-bit EBFP numbers are the same for all numbers. Other schemes may be used, such as IEEE round-to-nearest (ties nearest even) or performing a logic OR operation between the guard bit and the significand least significant bit (lsb). Rounding can occur across the boundary between the two EPFP representations. The largest exponent difference that can be represented with 5 bits is 31. In one embodiment of EBFP, this value represents zero when the sign bit is 0 or (optionally) Not a Number (IEEE NaN or unsigned Infinity) when the sign bit is 1.

FIG. 2A is a diagrammatic representation of computer storage 200 of an EBFP number, in accordance with various representative embodiments. The embodiment shown uses a single tag bit. Other embodiments may use tags of two or more. The storage includes a shared exponent (SH-EXP) 202 and payloads (selectable words) 204, 206 and 208.

First word 204 includes sign bit 210, 1-bit tag 212, and a payload consisting of fields 214, 216, 218 and 220. The tag bit 212 is set to zero to indicate that the payload is associated with a significand. Fields 214, 216 and 218 indicate a difference between the shared exponent 202 and the exponent of the number being represented. Field 214 contains L zeros, where L may be zero. Field 216 contains a “one” bit, and field 218 contains an R-bit integer, where R is a designated integer. The factor 2^{(R+1)} is herein referred to as the “radix” of the representation, so the radix is 2 when R=0, 4 when R=1, and 8 when R=2. Field 218 is omitted when R=0. In this example, the exponent difference is given by 2^{R}×L+P. However, in general, the exponent difference is a function of L, P and (optionally) the tag value. Field 220 is a rounded and right-shifted fractional part of the significand. The total number of bits in the payload is fixed. Since the number of zeros in field 214 is variable, the number of bits, T, in the fraction field varies accordingly. When the integer value of field 220 is F, the significand is given 1+2^{-T}×F, which may be denoted by 1.fff . . . f. Thus, when the shared exponent is se, the number represented is

x=2^{se}×2⁻⁽²^{^{R}}^{L+P)}×(1+2^{-T}×F).

In one embodiment, the designated number R is zero and the radix is two. In this case

x=2^{se}×2^{-L}(1,+2^{-T}×F),

and the payload is simply the right-shifted significand. The exponent difference may be determined by counting the number of leading zeros in the EBFP number.

In second payload 206, the payload 222 is set to zero. When the tag bit is zero, the payload represents the number zero. When the tag bit is one, the payload represents an exponent difference of −1. This can occur when rounding causes the maximum value to overflow. Thus, the number represented is 2^{se+1}.

In payload 208, the tag bit is set to one to indicate that the payload 224 relates only to the exponent difference. When the payload is an integer E, the number represented is 2^{se+E+bias} where bias is an offset or bias value. The bias value is included since some small values of exponent difference can represented by payload 204.

In the coding of the tag and exponent difference, each bit has two states indicated by 1 and 0. It will be apparent to those of skill in the art that, herein, the states may equivalently be represented by 0 and 1.

TABLE 3 shows how output values are produced based on an exponent difference for an example implementation where the payload has 8 bits and includes a sign bit, a tag bit and 6 payload bits. In this example, R=0, so the radix is 2. The format is designated “8r2”. In the table below, “f” denotes fractional bit of the input value and “e” denotes one bit of the biased exponent difference.

TABLE 3
EBFP 8r2, 1-bit tag Format

| | Rounded & | Output | |
|---|---|---|---|
| Exponent | Shifted | Sign, Tag, | Notes: |
| Difference | Significand | Payload[5:0] | R-0, exp-diff = L |
| 0 | 1.fffff | s 0 1fffff | L = 0 |
| 1 | 1.ffff | s 0 01ffff | L = 1 |
| 2 | 1.fff | s 0 001fff | L = 2 |
| 3 | 1.ff | s 0 0001ff | L = 3 |
| 4 | 1.f | s 0 00001f | L = 4 |
| 5 | 1.0 | s 0 000001 | L = 5 |
| Any | Zero | X 0 000000 | |
| 0 | 10.0 | s 1 000000 | Overflow due to rounding |
| 6-68 | Any | s 1 eeeeee | exp-diff = 6 + eeeeee |
| >68 | Any | 0 1 111111 | Underflow |
| | NaN | 1 1 111111 | Not a number |

For zero tag, the bits indicated in bold font indicate the encoding of the exponent difference. In this example, the payload is equivalent to a right-shifted significand, including an explicit leading bit. Note that for an exponent difference greater than 5, the right-shifted significand is lost because of the limited number of bits. For an exponent difference greater than 5, only the exponent difference is encoded with a bias of 6.

In the embodiment shown in TABLE 3, the exponent difference can be decoded from the EBFP number by counting the number of leading zeros in the payload. This operation is denoted as CLZ(payload).

TABLE 4 shows the result of the example dot product computation described above. The exponents and signs of FP values with smaller exponents are retained. The resulting error compared to the true result is 13%. This is much improved compared to conventional BFP, which gave the results as zero. The accuracy of the EBFP approach is sufficient for many applications, including training convolutional neural networks.

TABLE 4

| Dot Product using Enhanced Block Floating Point | | | | | |
|---|---|---|---|---|---|
| Op A (p + 20) | | Op B (p + 19) | | Op A × Op B | |
| +0x1.0p − 17 | (1.00 × 2⁻¹⁷) | −0x1.0p − 5 | (−1.00 × 2⁻⁵) | −0x1.0p−22 | (−1.00 × 2⁻²²) |
| −0x1.cc | (−1.80 × 2²⁰) | +0x1.0p − 6 | (1.00 × 2⁻⁶) | −0x1.ccp + 14 | (−1.80 × 2¹⁴) |
| +0x1.0p + 7 | (1.00 × 2⁷) | +0x1.de | (1.87 × 2¹⁹) | +0x1.dep + 26 | (1.87 × 2²⁶) |
| −0x1.0p + 11 | (−1.00 × 2¹¹) | −0x1.0p + 0 | (−1.00 × 2⁰) | +0x1.0p+11 | (1.00 × 2¹¹) |
| +0x1.0p − 12 | (1.00 × 2⁻¹²) | +0x1.0p − 10 | (1.00 × 2⁻¹⁰) | +0x1.0p−22 | (1.00 × 2⁻²²) |
| −0x0.ed | (−0.93 × 2²⁰) | −0x1.0p + 9 | (1.00 × 2⁹) | +0x1.dap+28 | (1.85 × 2²⁸) |
| +0x1.0p − 17 | (1.00 × 2⁻¹⁷) | −0x0.05 | (−0.02 × 2¹⁹) | −0x1.40p − 4 | (−1.40 × 2⁻⁴) |
| +0x1.0p − 7 | (1.00 × 2⁻⁷) | +0x1.0p − 20 | (1.00 × 2⁻²⁰) | +0x1.0p − 27 | (1.00 × 2⁻²⁷) |

| | | |
|---|---|---|
| EBFP Result | +0x1.28bdp + 29 | (1.16 × 2²⁹) |

FIG. 2B is a diagrammatic representation of computer storage 206′ of an EBFP number, in accordance with various representative embodiments. EBFP format includes a number of fields. The order of the fields may be varied without departing from the present disclosure. For example, in FIG. 2B, the R-bit integer field 218 follows the tag 212. The “one” field 216 is used to terminate the L-leading zeros field 214. This field has a variable length. The length of field 220 varies accordingly, with L+T being constant. Other variations will be apparent to those of ordinary skill in the art. In general, the exponent difference and fractional part (if any) are encoded to produce a tag and a payload, with the tag indicating how the payload is to be interpreted.

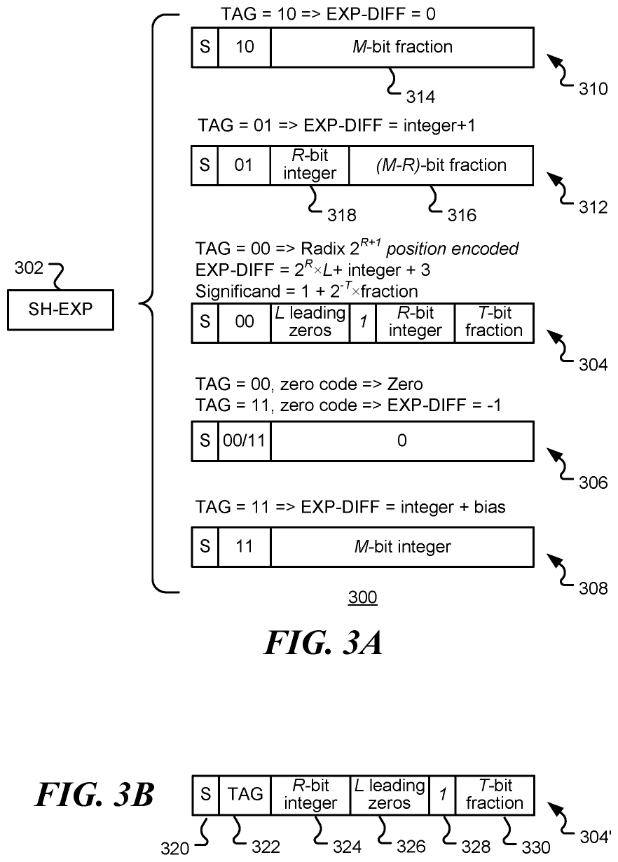

FIG. 3A is a diagrammatic representation of computer storage 300 of an EBFP number, in accordance with various representative embodiments. The embodiment shown uses a 2-bit tag. The storage includes a shared exponent (SH-EXP) 302 and selectable payloads 304, 306, 308, 310, and 312. Payloads 304, 306, 308 correspond to payloads 204, 206 and 208 in the format with a 1-bit tag. However, the bias may be different. The length of the payload is 1-bit shorter because of the extra tag bit. The format includes a first additional payload 310, identified by a tag 10, that stores the fractional part 314 of the significand rounded to M-bits, where M is the length of the payload field. The exponent difference is zero. The format also includes a second additional payload 312, identified by a tag 01, that stores the fractional part 316 of the significand rounded to (M−R+1)−bits, together with an R-bit integer 318. The exponent difference is one. For R=1, the payload is the rounded significand and the exponent difference is one. For R=2, the exponent difference is one when the first bit of the payload is zero, and two when the first bit of the payload is one.

TABLE 5 shows how output values are produced based on an exponent difference for an example implementation where the payload has 8 bits and includes a sign bit, two tag bits and 5 payload bits. In this example, R=0. In the table below, “f” denotes fractional bit of the input value and “e” denotes one bit of the biased exponent difference. Is this embodiment, the exponent difference can be decoded from the EBFP number by counting the number of leading zeros in the tag and payload. This operation is denoted as CLZ(tag, payload).

TABLE 5
EBFP 8r2, 2-bit tag Format

| | Rounded & | Output | Notes: |
|---|---|---|---|
| Exponent | Shifted | Sign, Tag[1:0], | R = 0, exp-diff = |
| Difference | Significand | Payload[4:0] | CLZ(tag, payload) |
| 0 | 1.fffff | s 10 fffff | CLZ(tag, payload) = 0 |
| 1 | 1.fffff | s 01 fffff | CLZ(tag, payload) = 1 |
| 2 | 1.ffff | s 00 1ffff | CLZ = 2 |
| 3 | 1.fff | s 00 01fff | CLZ = 3 |
| 4 | 1.ff | s 00 001ff | CLZ = 4 |
| 5 | 1.f | s 00 0001f | CLZ = 5 |
| 6 | 1.0 | s 00 00001 | CLZ = 6 |
| | Zero | X 00 00000 | |
| 0 | 10.00000 | s 11 00000 | Overflow due to round- |
| | | | ing (L = −3) |
| 7-37 | Any | s 11 eeeee | exp-diff = 7 + eeeee |
| >37 | Any | 0 11 11111 | Underflow |
| | NaN | 1 11 11111 | Not a number |

TABLES 4 and 5 above, illustrate how an output payload can be obtained from an exponent difference and a significand.

TABLE 6 shows how output values are produced based on an exponent difference for an example implementation where the payload has 8 bits and includes a sign bit, a tag bit and 6 payload bits. In this example, R=1, so the radix is 4. In the table below, “f” denotes fractional bit of the input value and “e” denotes one bit of the biased exponent difference.

TABLE 6
EBFP 8r4, 2-bit tag Format

| Exponent | Rounded & | Output | Notes: |
|---|---|---|---|
| Difference | Shifted | Sign, Tag[1:0], | R = 1, exp-diff = 2 × |
| p = 0 or 1 | Significand | Payload[4:0] | CLZ(tag, payload) + p − 1 |
| 0 | 1.fffff | s 10 fffff | Special case: p = 1 is assumed |
| 1 + p | 1.ffff | s 01 pffff | CLZ = 1 |
| 3 + p | 1.fff | s 00 1pfff | CLZ = 2 |
| 5 + p | 1.ff | s 00 01pff | CLZ = 3 |
| 7 + p | 1.f | s 00 001pf | CLZ = 4 |
| 9 + p | 1.0 | s 00 0001p | CLZ = 5 |
| 11 | 1.0 | s 00 00001 | CLZ = 6, hidden p = 0 |
| | Zero | X 00 00000 | |
| 0 | 10.0 | s 11 00000 | Overflow due to rounding |
| 12-42 | Any | s 11 eeeee | exp-diff = 12 + eeeee |
| >42 | Any | 0 11 11111 | Underflow |
| | NaN | 1 11 11111 | Not a number |

FIG. 3B is a diagrammatic representation of computer storage 304′ of an EBFP number, in accordance with various representative embodiments. In FIG. 3B, the order of the fields is changed, with the R-bit integer field 324 following the tag field 3222. The “one” field 328 is used to terminate the L-leading zeros field 326. Examples of this arrangement are discussed in more detail below.

TABLE 7, below, shows an example encoding using storage 304′ in FIG. 3B. In this example, the exponent difference is given by 2^{R}×(CLZ+tag)+p, when tag=01, and by 2^{R}×tag+p when tag=00 or 01 (R=1 in this example).

TABLE 7
Alternative EBFP 8r4, 2-bit tag (R = 1) Format

| Sign: Tag:Payload | Floating-Point Equivalent |
|---|---|
| s 11 ddddd | (−1)^{s} × 1.0 × 2\hat{ }(shexp − ddddd − 13) |
| s 11 11111 | (−1)^{s} × 1.0 × 2\hat{ }(shexp + 1) |
| 0 11 00000 | Zero |
| 1 11 00000 | NaN |
| s 00 pffff | (−1)^{s} × 1.fffff × 2\hat{ }(shexp − p) |
| s 01 pffff | (−1)^{s} × 1.ffff × 2\hat{ }(shexp − p − 2) |
| s 10 plfff | (−1)^{s} × 1.fff × 2\hat{ }(shexp − p − 4) |
| s 10 p01ff | (−1)^{s} × 1.ff × 2\hat{ }(shexp − p − 6) |
| s 10 p001f | (−1)^{s} × 1.f × 2\hat{ }(shexp − p − 8) |
| S 10 p0001 | (−1)^{s} × 1.0 × 2\hat{ }(shexp − p − 10) |
| s 10 p0000 | (−1)^{s} × 1.0 × 2\hat{ }(shexp − p − 12) |

The payload is made up an encoded exponent difference concatenated with a number (possibly 0) of fraction bits (ff . . . f), where the encoded exponent difference includes a number (possibly 0) of bits set to zero, at least one bit set to one, and a number (possibly 0) of additional bits (p).

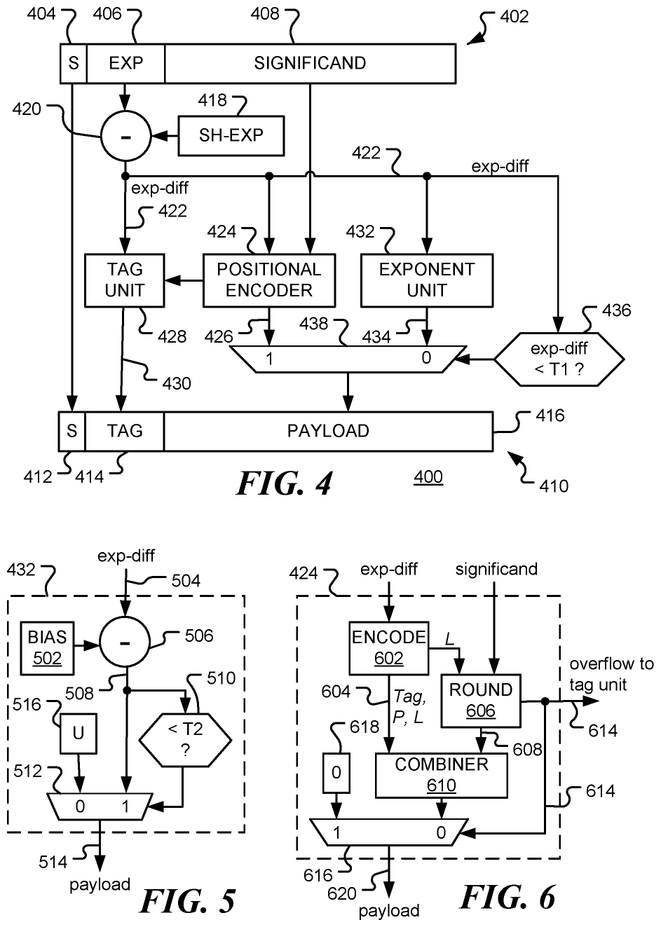

FIG. 4 is a block diagram of an apparatus 400 for converting a floating-point number into an enhanced block floating-point number, in accordance with various embodiments. The floating-point (FP) number 402 is stored as a sign bit 404, an exponent 406 and significand 408. The leading “1” bit in significand 408 may be explicit or hidden. FP number 402 processed to provide an EBFP output storage 410, which is stored as a sign bit 412, one- or two-bit tag 414, and payload 416. A base or shared exponent value 418 is subtracted, in subtraction unit 420, from exponent 406 of the input value to produce exponent difference 422. Exponent difference 422 is passed to positional encoder 424 that produces a first payload 426, tag unit 428 that produces tag value 430 and exponent unit 432 that produces a second payload 434. The exponent difference is compared to a first threshold in comparator 436. When the exponent different is greater than or equal to the first threshold, selector 438 selects second payload 434 to be stored in the payload 416 of EBFP output storage 410. Otherwise, selector 438 selects first payload 426 to be stored. Tag 414 indicates whether payload 416 contains a first or second payload. A 2-bit tag value may also indicate the format of the first payload 426.

FIG. 5 is a block diagram of an exponent unit 432, in accordance with various embodiments. A bias value 502 is subtracted from an input exponent difference 504 in subtraction unit 506 to produce a biased exponent difference 508. The biased exponent difference 508 is compared to a second threshold in comparator 510. When the biased exponent difference 508 is less than a second threshold T2, selector 512 selects the biased exponent difference 508 as the output payload 514. Otherwise, a designated value 516 (“U”) is selected as the output payload, indicating that the number has underflowed and has been set to zero. In one embodiment, the designated value is the maximum representable number, i.e., all “ones.” In this embodiment, the output payload may be obtained by clipping biased exponent difference 508 at the maximum representable number. Bias value 502 may be selected dependent upon how many exponent differences can be represented in the significand payload format.

FIG. 6 is a block diagram of a positional encoder 424, in accordance with various embodiments. Positional encoder 424 receives the exponent difference and significand as inputs. The exponent difference is encoded in unit 602 to determine values of P, a number of leading zeros L, and the tag. The number of bits in resulting exponent difference code 604 depends upon the exponent difference. The significand is rounded, in unit 606, to a number of bits determined based on the length of exponent difference code 604. The exponent difference code 604 and rounded significand 608 are combined in combiner 610 to produce an output payload 612. In a special case, the significand may overflow when rounded. In this case, a signal 614 is sent to the tag unit to generate a special tag. In addition, selector 616 selects a corresponding designated special code as the final output payload 618. Positional encoder 424 is referred to as a “positional” encoder since the payload is interpreted dependent upon the position of certain bits in the payload.

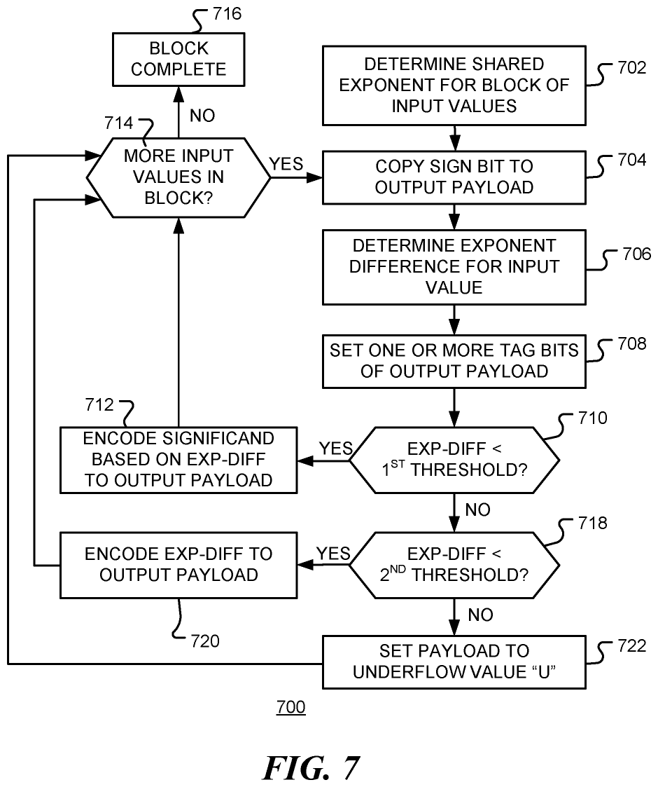

FIG. 7 is a flow chart of a computer-implemented method 700 for converting a floating-point (FP) number into an enhanced block floating point (EBFP) number, in accordance with various embodiments of the disclosure. At block 702 a shared exponent is determined for a block of input values. For example, the shared exponent may be the maximum exponent of the input values. At block 704, a sign bit of the input FP number in the block is copied to a sign bit of the output EBFP number. At block 706, the exponent difference between the shared exponent and the exponent of the input FP number is determined and, at block 708, one or more tag bits of the output EBFP number are set based on the exponent difference. At decision block 710, the exponent difference is compared to a first threshold. When the exponent difference is less than the first threshold, as depicted by the positive branch from decision block 710, the significand of the input FP number is encoded at block 712 based on the exponent difference and stored in the output EBFP number. When there are more FP numbers in the block to be converted, as depicted by the positive branch from decision block 714, flow continues to block 704 to convert another input FP number. Otherwise, conversion of the block is complete, as indicated by block 716.

When the exponent difference is not less than the first threshold, as depicted by the negative branch from decision block 710, flow continues to decision block 718. When the exponent difference of the input FP number is less than a second threshold value, as depicted by the positive branch from decision block 718, the exponent difference is encoded to the output EBFP number at block 720. For example, the output payload may be a biased exponent difference. When the exponent difference of the input FP number is not less than a second threshold value, as depicted by the negative branch from decision block 718, the output payload is set, at block 722, to a designated value to indicate underflow. The resulting EBFP number represents zero. Flow continues to decision block 714.

By this method, the payload in the resulting EBFP number may represent an exponent-difference, an exponent-difference and a significand, or a special value such as zero. The one or more tag bits indicate how the payload is to be interpreted.

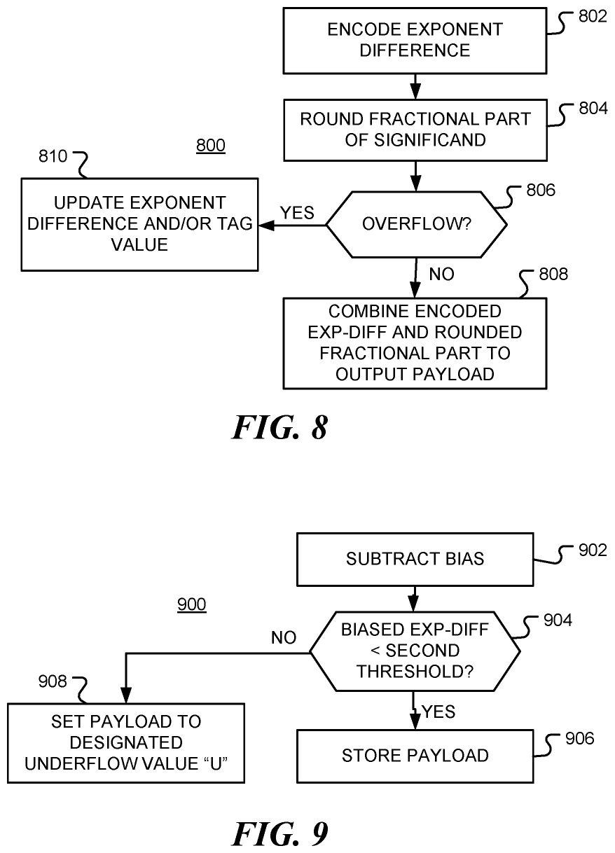

FIG. 8 is a flow chart of a method 800 for encoding a significand to a EBFP number, in accordance with various embodiments. At block 802, an exponent difference is encoded as L zeros, a “one” bit and, optionally, an R-bit integer P, where exponent difference is given by 2^{R}×L+P+offset, as described above. R may have the value zero, in which case the R-bit integer is omitted. For a payload length of Mbits, the significand is rounded to M-L-R-I bits at block 804. If rounding the significand does not cause it to overflow, as depicted by the negative branch from decision block 806, the output payload is obtained by combining the encoded exponent difference and the rounded significand to produce the output payload at block 808. However, if rounding the significand causes it to overflow, as depicted by the positive branch from decision block 806, the output payload and/or tag are modified at block 810. For example, the exponent difference may be reduced, which, in turn may require the tag value and the encoding scheme to be changed.

FIG. 9 is a flow chart of a method 900 for encoding an exponent difference to a EBFP number, in accordance with various embodiments. At block 902, a bias value is subtracted from the exponent difference of an input value. When the biased exponent difference is less than a second threshold, as depicted by the positive branch from decision block 904, the biased exponent difference is stored, at block 906, as the payload in the output. When the biased exponent difference is not less than a second threshold, as depicted by the negative branch from decision block 904, the payload is set to zero or some other designated value at block 908 to indicate that the FP number has underflowed in the conversion. In one embodiment, the biased exponent difference is clipped to the maximum value when underflow occurs. All of the bits in payload are set to one.

The example number formats described above use 8-bit words. This enables computations to be made using shorter word lengths. This is advantageous, for example, when a large number of values is being processed for when memory is limited. In some applications, such as accumulators, more precision is needed. An EBFP format using 16-bit words is described below. In general, the format using M-bit words, where M can be any number (e.g., 8, 16, 24, 32, 64 etc.).

In one embodiment using 16-bit words, all EBFP16 numbers have an additional eight fraction bits than in EBFP8, while the range of exponent differences is the same as in EBFP8. EBFP16 may be used where a wider storage format is needed and provides better accuracy than the “bfloat” format. In addition, the combination of a shared exponent and an exponent difference provides a wider exponent range.

TABLE 8 below gives an example of an EBFP16r2 (radix 2) format with two tag bits. Note that for exponent differences in the range 7-37, the last eight bits of the payload contain the fractional part of the number, while the first 5 bits contain the exponent. In this case, the payload is similar to floating point representation of the input, except that the exponent is to be subtracted from the shared exponent.

TABLE 8

| | Rounded & | Output |
|---|---|---|
| Exponent | Shifted | Sign, Tag[1:0], |
| Difference | Significand | Payload[12:0] |
| 0 | 1.fffff ffffffff | s 10 fffff ffffffff |
| 1 | 1.fffff ffffffff | s 01 fffff ffffffff |
| 2 | 1.ffff ffffffff | s 00 1ffff ffffffff |
| 3 | 1.fff ffffffff | s 00 01fff ffffffff |
| 4 | 1.ff ffffffff | s 00 001ff ffffffff |
| 5 | 1.f ffffffff | s 00 0001f ffffffff |
| 6 | 1. ffffffff | s 00 00001 ffffffff |
| | Zero | X 00 00000 xxxxxxxx |
| 0 | 10.0 | s 11 00000 xxxxxxxx |
| 7-37 | 1. ffffffff | s 11 eeeee ffffffff |

TABLE 9 below gives an example of an EBFP16r4 (radix 4) format with two tag bits.

TABLE 9

| Exponent | Rounded & | Output |
|---|---|---|
| Difference | Shifted | Sign, Tag[1:0], |
| p = 0 or 1 | Significand | Payload[12:0] |
| 0 | 1.fffff ffffffff | s 10 fffff ffffffff |
| 1 + p | 1.ffff ffffffff | s 01 pffff ffffffff |
| 3 + p | 1.fff ffffffff | s 00 1pfff ffffffff |
| 5 + p | 1.ff ffffffff | s 00 01pff ffffffff |
| 7 + p | 1.f ffffffff | s 00 001pf ffffffff |
| 9 + p | 1. ffffffff | s 00 0001p ffffffff |
| 11 | 1. ffffffff | s 00 00001 ffffffff |
| | Zero | X 00 00000 xxxxxxxx |
| 0 | 10.0 | s 11 00000 xxxxxxxx |
| 12-42 | 1. ffffffff | s 11 eeeee ffffffff |

In one embodiment, an EBFP number is encoded in a first format of the form “s:tag:P:1:F” or second format of the form “s:tag:D”. where “s” is a sign-bit, “tag” is one or more bits of an encoding tag, “P” is R encoded exponent difference bits, “F” is a fraction and “D” is an exponent difference. Except for a subset of tag values, the floating-point number represented has significand 1.F and exponent difference 2^{R}×(tag+CLZ)+P, where CLZ is the number of leading zeros in the fraction F. For a first special tag value (e.g., all ones), the second format is used where the exponent difference is D plus a bias offset.

Some example embodiments for an 8-bit EBFP number are given below in TABLE 10.

TABLE 10
1-bit tag, R = 0

| Tag:Payload | Floating-Point Equivalent |
|---|---|
| 1 dddddd | 1.0 * 2\hat{ }(shexp − dddddd − 5) |
| 1 111111 | 1.0 * 2\hat{ }(shexp + 1) |
| 1 000000 | Zero |
| 0 1fffff | 1.fffff * 2\hat{ }shexp |
| 0 01ffff | 1.ffff * 2\hat{ }(shexp − 1) |
| 0 001fff | 1.fff * 2\hat{ }(shexp − 2) |
| 0 0001ff | 1.ff * 2\hat{ }(shexp − 3) |
| 0 00001f | 1.f * 2\hat{ }(shexp − 4) |
| 0 000001 | 1.1 * 2\hat{ }(shexp − 5) |
| 0 000000 | 1.0 * 2\hat{ }(shexp − 5) |

In contrast with the embodiments discussed above, the positions of the one or more “p” bits are fixed as the leading bits in the payload. With an 8-bit data, R may be in the range 0-5. Some examples are listed below in TABLES 11-15.

TABLE 11
1-bit tag, R = 1

| Tag:Payload | Floating-Point Equivalent |
|---|---|
| 1 dddddd | 1.0 * 2\hat{ }(shexp − dddddd − 8) |
| 1 111111 | 1.0 * 2\hat{ }(shexp + 1) |
| 1 000000 | Zero \hat{ } |
| 0 p1ffff | 1.ffff * 2\hat{ }(shexp − p) |
| 0 p01fff | 1.fff * 2\hat{ }(shexp − p − 2) |
| 0 p001ff | 1.ff * 2\hat{ }(shexp − p − 4) |
| 0 p0001f | 1.f * 2\hat{ }(shexp − p − 6) |
| 0 p00001 | 1.1 * 2\hat{ }(shexp − p − 8) |
| 0 p00000 | 1.0 * 2\hat{ }(shexp − p − 8) |

TABLE 12
2-bit tag, R = 0

| Tag:Payload | Floating-Point Equivalent |
|---|---|
| 11 ddddd | 1.0 * 2\hat{ }(shexp − ddddd − 6) |
| 11 11111 | 1.0 * 2\hat{ }(shexp + 1) |
| 11 00000 | Zero |
| 00 fffff | 1.fffff * 2\hat{ }shexp |
| 01 fffff | 1.fffff * 2\hat{ }(shexp − 1) |
| 10 1ffff | 1.ffff * 2\hat{ }(shexp − 2) |
| 10 01fff | 1.fff * 2\hat{ }(shexp − 3) |
| 10 001ff | 1.ff * 2\hat{ }(shexp − 4) |
| 10 0001f | 1.f * 2\hat{ }(shexp − 5) |
| 10 00001 | 1.1 * 2\hat{ }(shexp − 6) |
| 10 00000 | 1.0 * 2\hat{ }(shexp − 6) |

TABLE 13
2-bit tag, R = 1

| Tag:Payload | Floating-Point Equivalent |
|---|---|
| 11 ddddd | 1.0 * 2\hat{ }(shexp − ddddd − 10) |
| 11 11111 | 1.0 * 2\hat{ }(shexp + 1) |
| 11 00000 | Zero |
| 00 pffff | 1.fffff * 2\hat{ }(shexp − p) |
| 01 pffff | 1.ffff * 2\hat{ }(shexp − p − 2) |
| 10 plfff | 1.fff * 2\hat{ }(shexp − p − 4) |
| 10 p01ff | 1.ff * 2\hat{ }(shexp − p − 6) |
| 10 p001f | 1.f * 2\hat{ }( shexp − p − 8) |
| 10 p0001 | 1.1 * 2\hat{ }(shexp − p − 10) |
| 10 p0000 | 1.0 * 2\hat{ }(shexp − p − 10) |

TABLE 14
1-bit tag, R = 2

| Tag:Payload | Floating-Point Equivalent |
|---|---|
| 1 dddddd | 1.0 * 2\hat{ }(shexp − dddddd − 15) |
| 1 111111 | 1.0 * 2\hat{ }(shexp + 1) |
| 1 000000 | Zero |
| 0 pp1fff | 1.fff * 2\hat{ }(shexp − pp) |
| 0 pp01ff | 1.ff * 2\hat{ }( shexp − pp − 4) |
| 0 pp001f | 1.f * 2\hat{ }(shexp − pp − 8) |
| 0 pp0001 | 1.1 * 2\hat{ }(shexp − pp − 12) |
| 0 pp0000 | 1.0 * 2\hat{ }( shexp − pp − 12) |

TABLE 15
3-bit tag, R = 1

| Tag:Payload | Floating-Point Equivalent |
|---|---|
| 111 dddd | 1.0 * 2\hat{ }(shexp − dddd − 16) |
| 111 1111 | 1.0 * 2\hat{ }(shexp + 1) |
| 111 0000 | Zero |
| 110 p1ff | 1.ff * 2\hat{ }(shexp − p − 12) |
| 110 p01f | 1.f * 2\hat{ }(shexp − p − 14) |
| 110 p00f | 1.f * 2\hat{ }(shexp − p − 16) |
| xxx pfff | 1. fff * 2\hat{ }(shexp − p − 2*xxx) |

In TABLE 15, “xxx” is any 3-bit combination except for the special values “111” and “110”.

Still further embodiments are given in TABLES 16-18.

TABLE 16
3-bit Tag

| | |
|---|---|
| 111 dddd | 1.0 * 2\hat{ }(shexp − 21 − dddd) |
| 111 1111 | 1.0 * 2\hat{ }(shexp + 1) |
| 111 0000 | e.g. Zero (S = 0); NaN/Inf (S = 1) |
| 0tt pfff | 1.fff * (2\hat{ }shexp − ttp) |
| 10t ppff | 1.ff * (2\hat{ }shexp − tpp − 8) |
| 110 plff | 1.ff * 2\hat{ }(shexp − p − 16) |
| 110 p01f | 1.f * 2\hat{ }(shexp − p − 18) |
| 110 p00f | 1.f * 2\hat{ }(shexp − p − 20) |

TABLE 17
4-bit Tag

| 0ttt fff | 1.fff * 2\hat{ }(shexp − ttt) |
|---|---|
| 10tt pff | 1.ff * 2\hat{ }(shexp − ttp − 8) |
| 110t pff | 1.ff * 2\hat{ }(shexp − tp − 16) |
| 1110 ppf | 1.f * 2\hat{ }( shexp − pp − 20) |
| 1111 ddd | 1.0 * 2\hat{ }(shexp − 23 − ddd) |
| 1111 111 | 1.0 * 2\hat{ }(shexp + 1) |
| 1111 000 | Zero (S = 0); NaN/Inf (S = 1) |

TABLE 18
4-bit Tag (0↔1)

| 1ttt fff | 1.fff * 2\hat{ }(shexp − ttt) |
|---|---|
| 01tt pff | 1.ff * 2\hat{ }(shexp − ttp − 8) |
| 001t pff | 1.ff * 2\hat{ }(shexp − tp − 16) |
| 0001 ppf | 1.f * 2\hat{ }( shexp − pp − 20) |
| 0000 ddd | 1.0 * 2\hat{ }(shexp − 23 − ddd) |
| 0000 111 | 1.0 * 2\hat{ }(shexp + 1) |
| 0000 000 | Zero (S = 0); NaN/Inf (S = 1) |

TABLE 18 is equivalent to TABLE 17 and illustrates how the use of zero and one in the part of the encoding shown in bold font may be reversed.

To improve accuracy when the number of fraction bits is reduced, rounding is used. Examples of rounding a 16-bit floating point number into EBFP8r2 and EBFP16r2 formats are now described. Bits shown in bold font are encoded in both EBFP8 and EBP16 formats. For clarity, these nits are separated by a space from the 8 trailing bits.

### Example 1: Floating-Point Number=+1.11010 10011111 01×2^{sh-exP}

For upper bits, the guard bit is G=1, while for the lower bits the guard bit is G=0. Thus, the EBFP8 format is: 0 10 11011, and the EBFP16 format is: 0 10 11011 10011111. In the EBFP format, 1 denotes a negative, 2's-complement, most significant bit of the lower bits.

### Example 2: Floating-Point Number=+1.1101 01001111 101×2^{(sh-exp-2)}

For the upper bits, the guard bit is G=0, while for lower bits the guard bit is G=1. Thus, the EBFP8 formatted number is: 0 00 11101, and the EBFP16 formatted number is: 0 00 11101 01010000.

Rounding to Nearest (Ties Away) generally results in the same most significant bits for both EBFP8 fraction bits as for EBFP16. However, there are some ‘corner’ cases.

### Example 3: Floating-Point Number=+1.1111 0111111 111×2^{(sh-exp-2)}

In this example, rounding the lower bits causes G=1 for upper bits. Thus, the EBFP8 formatted number is: 0 00 11111, and the EBFP16 formatted number is: 0 01 00000 10000000. However, this is equivalent to 0 00 11111 10000000 (but with positive most significant bit in lower 8 bits). In this case, the EBFP8 and EBFP16 MSB's do not match but are numerically equal. In one embodiment, when rounding from EBFP16 to EBFP8, the EBFP8 payload is decremented if the bottom 8 bits of EBFP16==0x80. Otherwise, the payload is truncated.

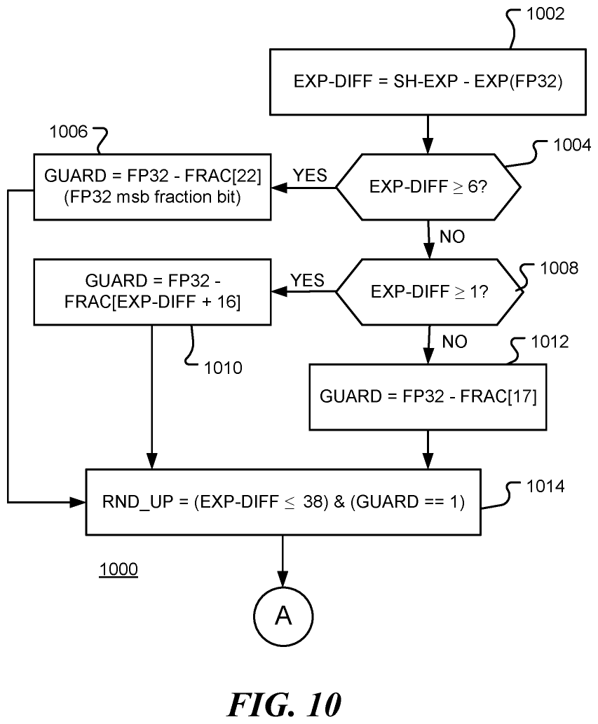

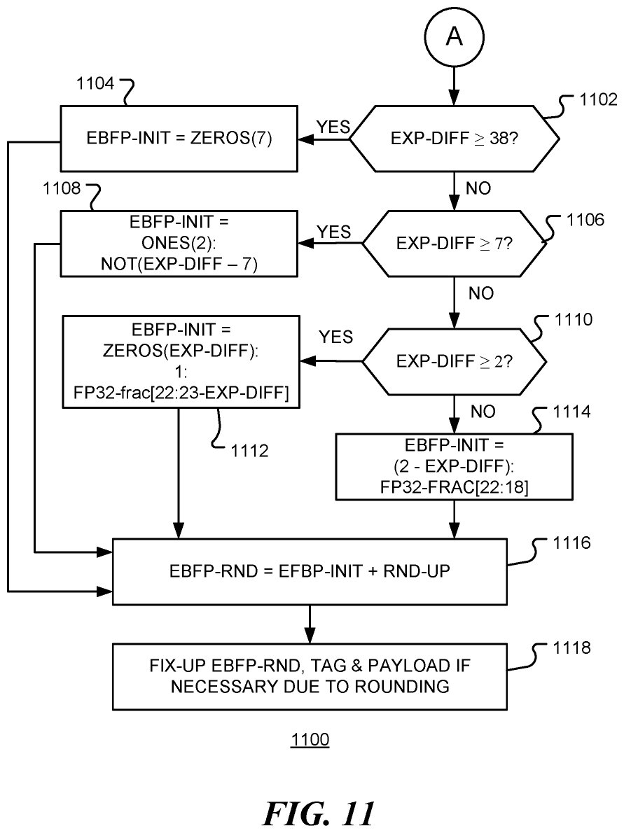

A method for rounding FP32 to EBFP8-r2 is described in FIGS. 10 and 11, described below, as an example. It will be apparent to those of skill in the art that methods for other formats can be readily derived from this one.

FIG. 10 is a flow chart of a method 1000 for rounding when converting from a 32-bit floating point number (FP32) to an 8-bit EBFP8r2 number with 8-bits. At block 1002, an exponent difference is determined. When the exponent difference is greater than or equal to 6, as depicted by the positive branch from decision block 1004, there is no fraction bit in the EBFP and a guard bit is set, at block 1006, to FP32-frac[22], i.e., the most significant fraction bit of FP32. Otherwise, flow continues to decision block 1008. When the exponent difference is greater than or equal to 2, as depicted by the positive branch from decision block 1008, the guard bit is set, at block 1010, to FP32-frac[exp-diff+16]. Otherwise, flow continues to block 1012 and the guard bit is set to FP32-frac[17]. At block 1014, a round-up bit (RND-UP) is set to “one” is exp-diff≤38 and the guard bit equals 1 and to “zero” otherwise. Flow than continues to point “A” in FIG. 11.

FIG. 11 is a flow chart of a method 1100 for converting from a 32-bit floating point number (FP32) to an 8-bit EBFP8r2 number with 8-bits. Once a rounded significand has been determined, as described above with reference to FIG. 10, flow continues at point “A”. When the exponent difference is greater than or equal to 38, as depicted by the positive branch from decision block 1102, an initial EBFP code is set to 7 zero bits at block 1104. Otherwise, when the exponent difference is greater than or equal to 7, as depicted by the positive branch from decision block 1106, the first 2 bits of the initial EBFP code are set to “one” and the remainder are set to the negation of (exponent difference −7) at block 1108. Otherwise, when the exponent difference is greater than or equal to 2, as depicted by the positive branch from decision block 1110, the initial EBFP code is set, at block 1112, to:

Zeros(exp-diff): “1”: FP32-frac [22:23-exp-diff]

Finally, when the exponent difference is less than 2, the initial EBFP code is set at block 1114 to:

{(2−exp-diff): FP32-frac[22:18]}.

At block 1116, the rounded EBFP code is set as the initial code plus the round-up bit.

When the exponent difference is 38, 7 or 0, and the round-up bit is one, the rounding operation may cause the tag value to change. In this case, the rounded EBFP, tag, and payload may be adjusted, as depicted by block 1118.

TABLE 16 shows conversions from FP32 into EBFP8-r2 for some example numbers, in accordance with various embodiments of the disclosure. The shared exponent is sh-exp=+4. For cases where the tag value changes when rounding is applied, the tag values are shown in bold font.

TABLE 16

| | FP32 input | | | | | | | | EBFP-rnd |
|---|---|---|---|---|---|---|---|---|---|
| FP32 input | (hex) | exp-diff | sign | tag-init | EBFP-init | L, G | rnd_up | EBFP-rnd | (FP32) |
| +1.fc0002p+4 | 0x41fe0001 | 0 | 0 | 10 | (1.)11111 | 1, 1 | 1 | 0 11 00000 | +1.00p+5 |
| −1.f80000p+4 | 0xc1fc0000 | 0 | 1 | 10 | (1.)11111 | 1, 0 | 0 | 1 10 11111 | −1.f8p+4 |
| +1.fc0002p+3 | 0x417e0001 | 1 | 0 | 01 | (1.)11111 | 1, 1 | 1 | 0 10 00000 | +1.00p+4 |
| +1.f7fffep+2 | 0x40fbffff | 2 | 0 | 00 | (0.)11111 | 1, 0 | 0 | 0 00 11111 | +1.f0p+2 |
| +1.c00002p+1 | 0x40600001 | 3 | 0 | 00 | 01110 | 0, 1 | 1 | 0 00 01111 | +1.e0p+1 |
| +1.000000p−1 | 0x3f000000 | 5 | 0 | 00 | 00010 | 0, 0 | 0 | 0 00 00010 | +1.00p−1 |
| +1.800002p−2 | 0x3ec00001 | 6 | 0 | 00 | 00001 | (x,)1 | 1 | 0 00 00010 | +1.00p−1 |
| +1.000000p−2 | 0x3e800000 | 6 | 0 | 00 | 00001 | (x,)0 | 0 | 0 00 00001 | +1.00p−2 |
| +1.800002p−3 | 0x3e400001 | 7 | 0 | 11 | 11111 | (x,)1 | 1 | 0 00 00001 | +1.00p−2 |
| +1.000000p−3 | 0x3e000000 | 7 | 0 | 11 | 11111 | (x,)0 | 0 | 0 11 11111 | +1.00p−3 |
| −1.7ffffep−4 | 0xbdbfffff | 8 | 1 | 11 | 11110 | (x,)0 | 0 | 1 11 11110 | −1.00p−4 |
| +1.000000p−4 | 0x3d800000 | 8 | 0 | 11 | 11110 | (x,)0 | 0 | 0 11 11110 | +1.00p−4 |
| +1.800002p−33 | 0x2f400001 | 37 | 0 | 11 | 00001 | (x,)1 | 1 | 0 11 00010 | +1.00p−32 |
| −1.7ffffep−33 | 0xaf3fffff | 37 | 1 | 11 | 00001 | (x,)0 | 0 | 1 11 00001 | −1.00p−33 |
| +1.800002p−34 | 0x2ec00001 | 38 | 0 | 00 | 00000 | (x,)1 | 1 | 0 11 00001 | +1.00p−33 |
| −1.7ffffep−34 | 0xaebfffff | 38 | 1 | 00 | 00000 | (x,)0 | 0 | 0 00 00000 | +0.0 |
| +1.800002p−35 | 0x2e400001 | 39 | 0 | 00 | 00000 | (x,)1 | 1 | 0 00 00000 | +0.0 |
| −1.7ffffep−35 | 0xae3fffff | 39 | 1 | 00 | 00000 | (x,)0 | 0 | 0 00 00000 | +0.0 |
| +1.000000p−35 | 0x2e000000 | 39 | 0 | 00 | 00000 | (x,)0 | 0 | 0 00 00000 | +0.0 |

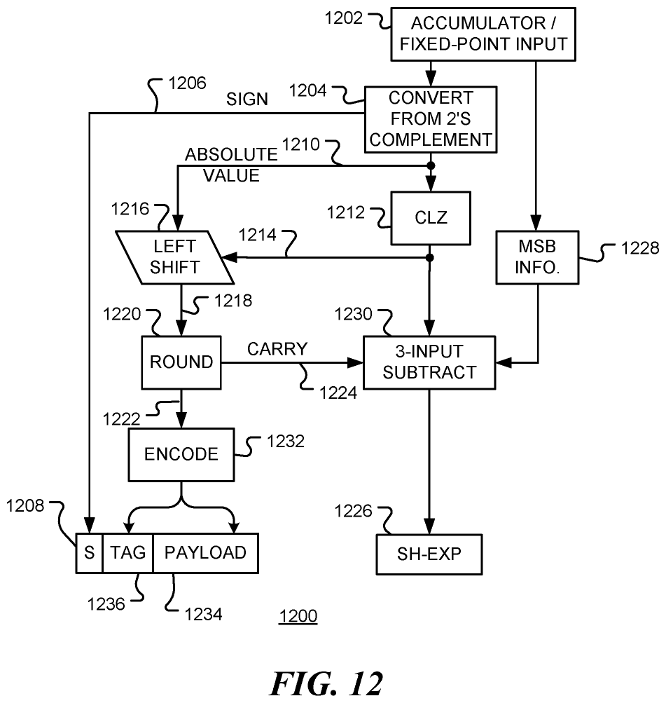

FIG. 12 is a block diagram of a data processing apparatus 1200, in accordance with various representative embodiments. Apparatus 1200 is configured to convert a fixed-point input datum 1202 into an EBFP-formatted output. Apparatus 1200 determines the number of leading sign-bits of the input datum. In the embodiment shown, the input datum is converted from a two's complement format in block 1204 to produce sign 1206, which is stored at 1208 in the EBFP-formatted output, and absolute value 1210. The leading zeros are counted in block 1212 to determine an initial exponent 1214 of the data input. The absolute value 1210 is shifted left by the number of leading sign-bits in unit 1216 to provide significand 1218. Significand 1218 is rounded to a designated number of bits to produce a rounded significand 1220 and carry bit 1224. The shared exponent 1226 associated with an output datum, is determined in MSB information unit 1228 based on the number of leading sign-bits, the carry bit 1224 and, optionally, the significance of the most significant bit of the input. For example, the final exponent may be computed by subtracting the number of sign bits from the carry bit and combining with MSB information 1228 in subtraction unit 1230. MSB information specifies the format of fixed-point input datum 1202 by specifying the position of the most significant bit (MSB) of the input datum. The significand is rounded to a designated number of bits in unit 1232 to produce payload 1234 and encoding tag 1236 of the output datum. The output datum, consisting of sign-bit 1208, payload 1234 and encoding tag 1236 are provided as output, together with shared exponent 1226. Thus, apparatus 1200 converts the fixed-point input datum 1202 to EBFP format.

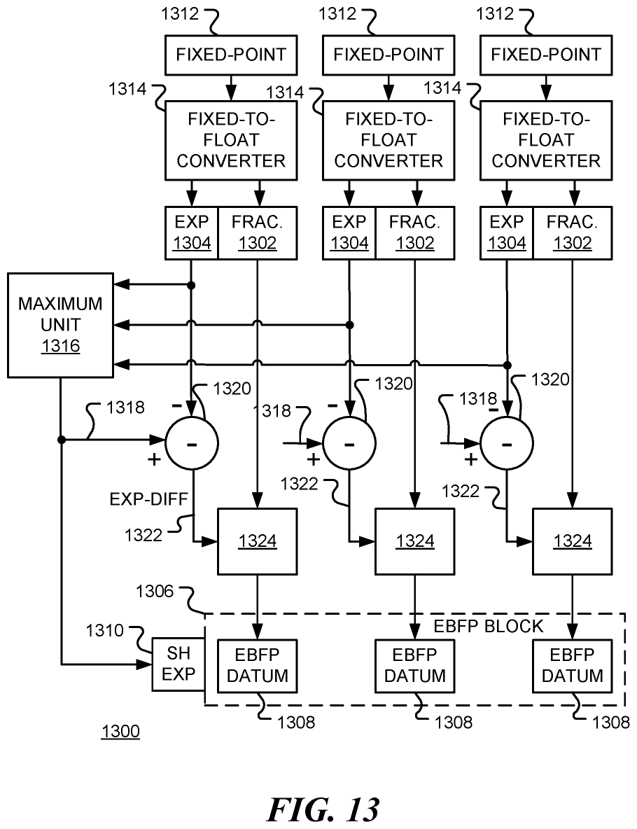

FIG. 13 is a block diagram of a data processing apparatus 1300, in accordance with various representative embodiments. Apparatus 1300 is configured to convert one or more input data into a block or vector of data in EBFP format. FIG. 13 shows three input data converted in parallel but, in general, any number of data may be converted in series, in parallel, or a combination thereof. The input data may be in a floating-point format that includes at least a fractional part 1302 of a significand, and an exponent 1304. The input data are converted to a block of EBFP-formatted data 1306 that includes one or more output data 1308 and a shared exponent 1310. Alternatively, the input data may be in fixed-point format 1312 and converted to floating-point data in converters 1314. Maximum unit 1316 of data processing apparatus 1300 is configured to determine a maximum exponent 1318 of input exponents 1304. Maximum exponent 1318 is stored as output shared exponent 1310. Subtraction units 1320 determine output exponent differences 1322 between the output shared exponent 1318 and the one or more input exponents 1304. Thus, the exponent of an output data 1308 may be determined from the shared exponent 1310 and the corresponding exponent difference 1322. Encoders 1324 encode the output exponent differences 1322 and corresponding input significands, or fractions, 1302 to produce output data 1308. An output data 1308 includes an encoding tag, indicative of how the exponent difference and significand were encoded, and a payload. The stored block output data 1308 and the stored shared exponent 1310 represent the block of EBFP-formatted data.

An encoder 1324 may be configured to round the input fractions (or significands) 1302 to a designated number of places. When a maximum value of the input data overflows when rounded, the shared exponent may be increased by one. This may be implemented, for example, by generating a carry bit that is summed with the maximum of the input exponents.

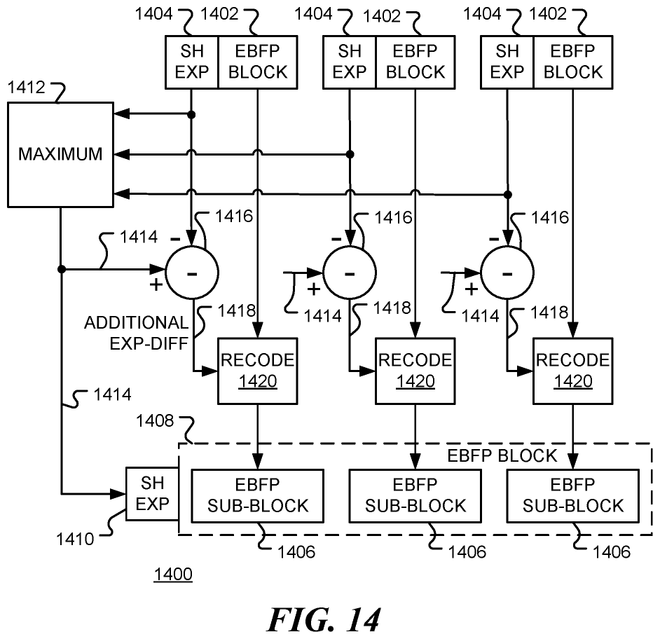

FIG. 14 is a block diagram of a data processing apparatus 1400, in accordance with various representative embodiments. Apparatus 1400 is configured to convert one or more blocks of input data in EBFP format into a larger block of data in the same EBFP format or a different EBFP format. FIG. 14 shows three blocks of input data converted in parallel but, in general, any number of blocks data may be converted in series, in parallel, or a combination thereof. An input block may include one or more values. A block of input data includes an EBFP encoded data block 1402 and a shared exponent 1404. A block of input data is converted to a sub-block of EBFP-formatted data 1406 in output EBFP block 1408. All data in output EBFP 1408 is associated with shared exponent 1410. Maximum unit 1412 of data processing apparatus 1400 is configured to determine a maximum shared exponent 1414 of the input shared exponents 1404. Maximum shared exponent 1414 is stored as output shared exponent 1410.

A datum in an EBFP block 1402 encodes an exponent difference and, where appropriate, at least a fractional part of the significand of an input number. Since the maximum shared exponent 1414 may be larger than the shared exponent 1404 of an input block, subtraction units 1416 determine additional exponent differences 1418 between the output shared exponent 1414 and the one or more input shared exponents 1404. In a recode unit 1420, the input exponent differences are decoded and combined with the additional exponent difference 1418 to produce output exponent differences. These, in turn, are encoded with the input fractions to produce the output encoded data 1408. No recoding is needed for any input block for which the additional exponent difference is zero—unless the data size or format is to be changed. When the data size is to be reduced, a rounding mechanism may be used, as described above.

Thus, in an embodiment where the input exponents are input shared exponents of input data blocks in an Extended Block Floating-Point (EBFP) format, the output exponent differences are produced by determining additional exponents differences between the maximum input exponent and the input shared exponents and then determining the output exponent differences as a sum of the additional exponent differences and exponent differences of data in the encoded input data blocks. Further, encoding the output exponent differences and the corresponding input significands to produce the output data includes recoding the data in the EBFP-formatted input data blocks based on the output shared exponent.

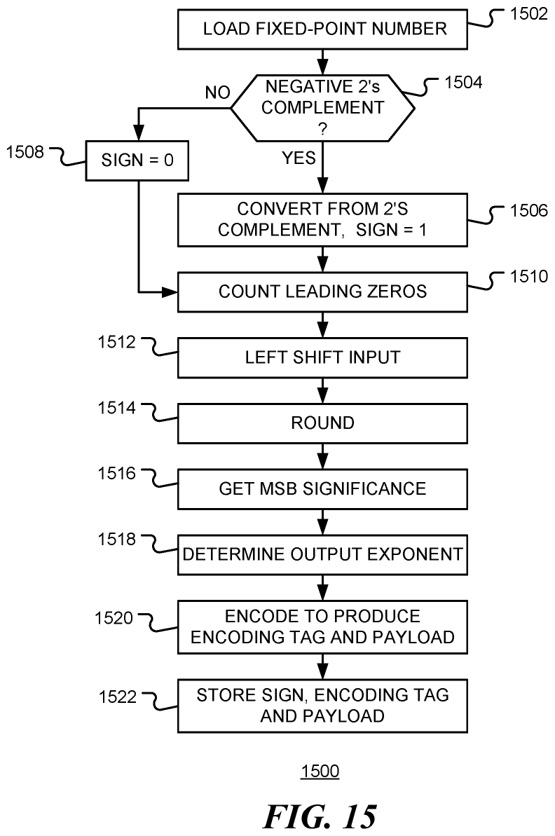

FIG. 15 is a flow chart of a computer-implemented method 1500 of converting an input datum to a number in EBFP format, in accordance with various representative embodiments. The number to be converted is loaded at block 1502. Next, an exponent of the input datum is determined. In the embodiment shown, the input datum is in a fixed-point format, but other formats may be converted in a similar manner. When the number is a negative number in two's complement format, as depicted by the positive branch from decision block 1504, the number is converted to an absolute value and the sign-bit is set to one at block 1506. Otherwise, as depicted by the negative branch from decision block 1504, the sign-bit is set to zero at block 1508. The exponent is determined, at block 1510, by counting the number of leading zeros. Alternatively, the number of leading sign bits could be counted before the absolute value is determined. At block 1512, the input is shifted left by the number of leading sign bits to provide a normalized significand of the input datum. The significand is rounded, at block 1514, to the designated number of fraction bits. The rounding process may cause a carry bit to be generated. Optionally, at block 1516, the significance of the most significant bit (MSB) of the input is retrieved. The input datum may represent a subset of bits from a higher precision number, for example, in which case the MSB significance indicates where the input bits are located within the higher precision number. For example, an accumulator may be divided into a number of “lanes” with overlapping regions. The overlapping regions may be set to zero to prevent erroneous calculation of the number of leading zeros. From the lowest lane up, sign-extended overlap regions are added to the next higher lane. The output shared exponent is determined, at block 1518, by combining the number of leading zeros with the carry bit and the MSB information. At block 1520, the shifted significand and exponent are encoded to produce an encoding tag and payload. Finally, at block 1522 the sign, encoding tag and payload are stored.

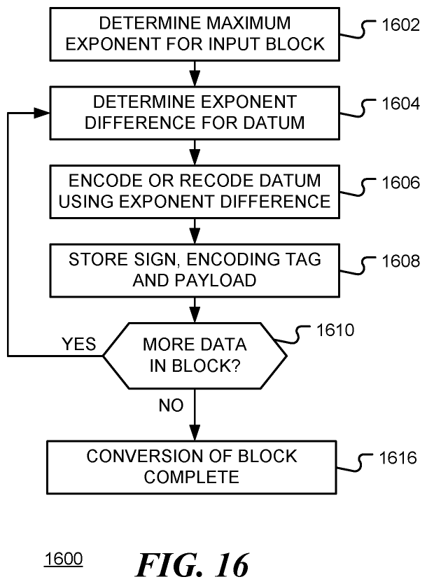

FIG. 16 is a flow chart of a computer-implemented method 1600 of converting one or more blocks of numbers in fixed-point, floating-point format, block floating-point, or a first Extended Block Floating-Point (EBFP) format into a single block of numbers in second EBFP format. At block 1602, a maximum exponent is determined for the input data. For fixed-point data, exponents are determined for all input data and then a maximum exponent is found. For floating-point data, each datum has its own exponent, so the maximum is found over all input data. For block-floating point data and EBFP data, the maximum is found for shared-exponent of the input blocks. At block 1604, an exponent difference is found for an input datum. For fixed- or floating-point data, the exponent difference is the difference between the maximum exponent and the exponent of the datum. For block-floating-point data, the exponent difference is found as the maximum exponent minus the shared exponent for the block, minus the number of leading sign bits in the datum. For EBFP data, the exponent difference is found as the maximum exponent minus the shared exponent for the block, minus the exponent difference for the datum. The exponent difference for the datum can be found by decoding the payload using the encoding tag. At block 1606, each input datum is encoded according to its value, as described above, to produce an encoding tag and a payload. For data with an exponent difference above a threshold value, the exponent difference is encoded. For smaller exponent differences, a combination of exponent difference and fractional part is encoded. The encoding tag identifies which encoding has been used. At block 1608, the sign, encoding tag and payload of the converted datum are stored. If there are more data to be converted, as depicted by the positive branch from decision block 1610, flow returns to block 1604. Otherwise, as depicted by the negative branch from decision block 1610, conversion of the block is complete at bock 1612.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Dedicated or reconfigurable hardware components used to implement the disclosed mechanisms may be described, for example, by instructions of a hardware description language (HDL), such as VHDL, Verilog or RTL (Register Transfer Language), or by a netlist of components and connectivity. The instructions may be at a functional level or a logical level or a combination thereof. The instructions or netlist may be input to an automated design or fabrication process (sometimes referred to as high-level synthesis) that interprets the instructions and creates digital hardware that implements the described functionality or logic.

The HDL instructions or the netlist may be stored on non-transitory computer readable medium such as Electrically Erasable Programmable Read Only Memory (EEPROM); non-volatile memory (NVM); mass storage such as a hard disc drive, floppy disc drive, optical disc drive; optical storage elements, magnetic storage elements, magneto-optical storage elements, flash memory, core memory and/or other equivalent storage technologies without departing from the present disclosure. Such alternative storage devices should be considered equivalents.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added or operations can be deleted, without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A data processing apparatus configured to:
determine a number of leading sign bits of an input datum in a fixed-point format;
shift the input datum based on the number of leading sign bits to provide a significand;
determine an output exponent associated with an output datum based on the number of leading sign bits;
encode the significand to produce a payload and an encoding tag of the output datum; and
store the output exponent and the output datum.

2. The data processing apparatus of claim 1, further configured to:
round the significand to a designated number of bits before encoding to produce a carry bit; and
determine the output exponent associated with the output datum based on the number of leading sign bits and the carry bit.

3. The data processing apparatus of claim 1, where:
for a first value of the encoding tag, the encoding tag and payload represent a rounded significand and an exponent difference between the number of leading sign bits and the output exponent; and
for a second value of the encoding tag, the payload represents the exponent difference.

4. The data processing apparatus of claim 1, where the input datum has a two's complement, fixed-point format, and where the data processing apparatus is further configured to:
determine a sign and an absolute value of the input datum; and
set a sign bit of the output datum based on the sign of the input datum.

5. The data processing apparatus of claim 1, where the input datum is at least part of an accumulated value, and where the data processing apparatus is further configured to:
determine a significance of input data in the accumulated value; and
determine the exponent associated with output datum based on the number of leading sign bits, a carry bit, and the significance of the input datum.

6. A data processing apparatus configured to:
determine an output shared exponent as a maximum of input exponents of a plurality of input data, the input data representable by the plurality of input exponents and a corresponding plurality of input significands;
determine output exponent differences between the output shared exponent and the plurality of input exponents;
encode the output exponent differences and the corresponding input significands to produce a plurality of output data, an output datum of the plurality of output data including an encoding tag and a payload; and
store the plurality of output data and the output shared exponent.

7. The data processing apparatus of claim 6, further configured to:
round a maximum value of the input data to produce a rounded significand and a carry bit; and
determine the shared exponent as a sum of the maximum of the input exponents and the carry bit.

8. The data processing apparatus of claim 6, further configured to convert a plurality of fixed-point input data to floating-point data that includes the input exponents and corresponding input significands.

9. The data processing apparatus of claim 8, where the input exponents comprise input shared exponents of input data blocks in an Extended Block Floating-Point (EBFP) format, each input data block including one or more data, and where determining the exponent differences comprises:
determining additional exponents differences between the maximum input exponent and the input shared exponents; and
determining the output exponents differences as a sum of the additional exponent differences and exponent differences of data in encoded input data blocks.

10. The data processing apparatus of claim 9, where encoding the output exponent differences and the corresponding input significands to produce the plurality of output data comprises recoding the data in EBFP-formatted input data blocks based on the output shared exponent.

11. A computer-implemented method comprising:
determining an exponent of an input datum;
shifting the input datum by the exponent of the input datum to produce a significand;
rounding the significand to a designated number of bits to produce a rounded significand and a carry bit;
determining an exponent associated with an output datum based on the exponent of an input datum and the carry bit;
encoding the significand to produce a payload of the output datum and an encoding tag of the output datum; and
outputting the exponent and the output datum.

12. The computer-implemented method of claim 11, where the input datum has a fixed-point format, and where determining the exponent of the input datum comprises determining a number of leading sign bits of the input datum.

13. The computer-implemented method of claim 11, where the input datum has an Extended Block Floating-Point (EBFP) format, and where determining the exponent of the input datum comprises subtracting an exponent difference of the input datum from a shared exponent associated with the EBFP-formatted input datum.

14. The computer-implemented method of claim 11, where the input datum has a two's complement fixed-point format, the method further comprising:
determining a sign and an absolute value of the input datum; and
setting a sign bit of the output datum based on the sign of the input datum.

15. The computer-implemented method of claim 11, where the input datum is at least part of an accumulated value, the method further comprising:
determining a significance of the input datum in the accumulated value; and
determining the exponent of the output datum based on the exponent of the input datum, the carry bit, and the significance of the input datum.

16. The computer-implemented method of claim 15, further comprising:
determining the accumulated value as a dot product of two data vectors.

17. The computer-implemented method of claim 11, where determining the exponent of the input datum comprises determining a maximum exponent of a plurality of input data.

18. The computer-implemented method of claim 11, where determining the exponent of the input datum comprises determining a maximum shared exponent of a plurality of input data in Extended Block Floating Point (EBFP) format.

19. The computer-implemented method of claim 11, where the encoding tag indicates whether the payload comprises a fractional part of the shifted significand, an exponent difference, or a combination thereof.

20. The computer-implemented method of claim 11, where:
for a first value of the encoding tag, the encoding tag and payload of the output datum specify a rounded significand and an exponent difference between the input exponent and the output exponent; and
for a second value of the encoding tag, the payload of the output datum specifies the exponent difference.
